(19) United States
(12) Patent Application Publication
(10) Pub. No.: US 2017/0009802 A1
(43) Pub. Date: Jan. 12, 2017

(54) IMPACT RESISTANT REMOVABLE MOUNTING SYSTEM

(71) Applicant: Underwater Kinetics, Poway, CA (US)

(72) Inventors: Alan Uke, Del Mar, CA (US); Andrew Zoolakis, Carlsbad, CA (US); Dan Wert, San Diego, CA (US)

(21) Appl. No.: 14/794,408

(22) Filed: Jul. 8, 2015

(51) Int. Cl. F16C 11/04; F16M 13/00; G03B 17/56

(52) U.S. Cl. CPC F16C 11/04; G03B 17/561; F16M 13/00

(57) ABSTRACT

Disclosed is a mount which may include a plurality of flanges configured to attach at least one device to the mount and a body having a pair of apertures substantially in line with one another. Disclosed also is a mount that may include a platform having a ripple configured to impart flexibility to the platform and a body having a pair of apertures substantially in line with one another.

### BACKGROUND

1. Field

Example embodiments relate to mounts which may be removably attached to a pole. In example embodiments the mounts may be configured to attach at least one device, for example, a camera, to an end of the pole.

2. Description of the Related Art

FIG. 1 is a view of system 50 for taking pictures. As shown in FIG. 1, the system 50 is comprised of a pole 10 having a camera 20 attached thereto. The pole 10 includes a grip 15 which may be grasped by a person to manipulate the pole 10 thereby manipulating the camera 20. The system 50 allows a person to take pictures of themselves from a range which is beyond the normal range of an arm. In the art, the pole 10 is often called a Selfie Stick.

FIGS. 2A and 2B are examples of conventional poles 10′ and 10″ often used as a selfie stick. The pole 10′ of FIG. 2A, for example, has a tubular by 12′ which has a fixed length. This type of pole is often referred to as a static pole. In FIG. 2A, at least a portion of the body 12′ of the pole 10′ has an annular cross-section. In some poles, the outer diameter DO′ of the body 12′ is about ⅞ of an inch. The pole 10″ of FIG. 2B is an extendable pole having an adjustable length. This type of pole 10″ is often comprised of two tubes arranged to have a telescoping action. In some extendible poles 10″ the outer diameter DO″ of an end of the pole 10″ is about 16 mm.

In the conventional art, custom mounts 30 are provided to attach the camera 20 to the pole 10 (10′ or 10″). The mounts 30 generally attach to the pole 10 using standard hardware and adhesives which render the mounts 30 permanently attached to the pole 10.

### SUMMARY

The inventor has noticed several drawbacks with conventional selfie sticks. First, as mentioned above, conventional mounts are generally permanently attached to the poles. Second, most mounts are configured to support only one camera. In order to overcome these drawbacks, the inventor designed a removable mount configured to support at least one camera. For example, in one nonlimiting embodiment, a removable mount may support a single camera. In another nonlimiting embodiment a removable mount may support two cameras. In yet another nonlimiting embodiment, a removable mount may support more than two cameras. Although example embodiments illustrate a selfie stick configured to support at least one camera, the invention is not limited thereto as the inventive concepts herein are applicable to attaching other devices, for example, cell phones, microphones, or radar equipment, to a pole.

In accordance with example embodiments a mount may include a plurality of flanges configured to attach at least one device to the mount and a body having a pair of apertures substantially in line with one another.

In accordance with example embodiments a mount may include a platform having a ripple configured to impart flexibility to the platform and a body having a pair of apertures substantially in line with one another.

### BRIEF DESCRIPTION OF THE DRAWINGS

Example embodiments are described in detail below with reference to the attached drawing figures, wherein:

FIG. 1 is a view of a system in accordance with the prior art;

FIGS. 2A and 2B are views of poles in accordance with the prior art;

FIGS. 3A-3E are views of a mount in accordance with example embodiments;

FIGS. 4A-4D illustrate a method of attaching a mount to a pole in accordance with example embodiments;

FIGS. 45-5D illustrate a method of attaching a mount to a pole in accordance with example embodiments;

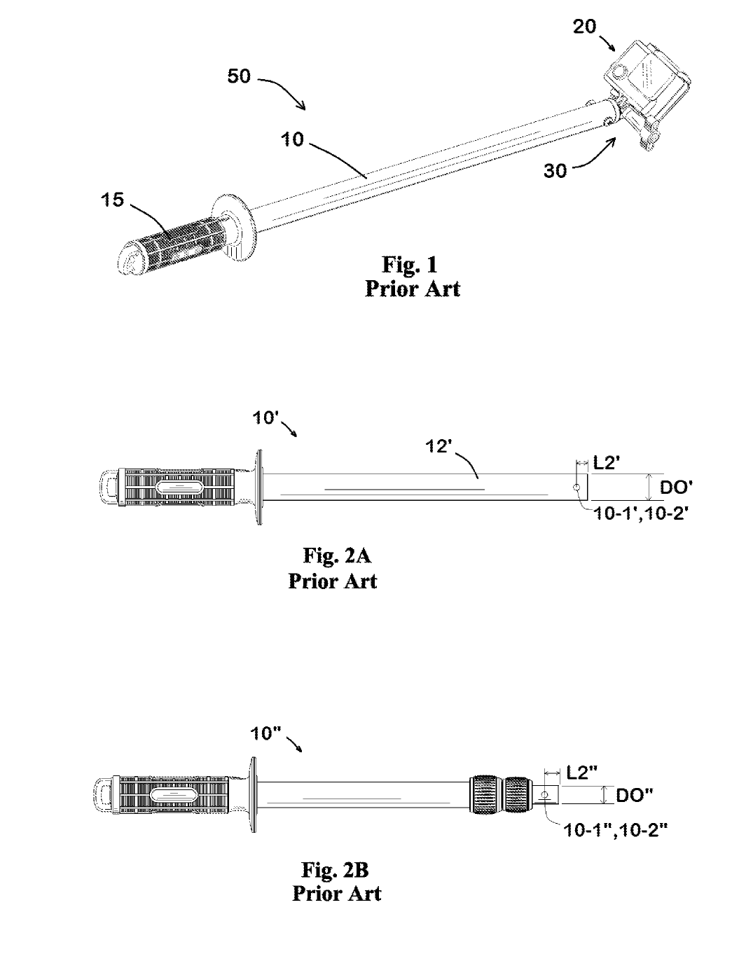

FIGS. 6A-6H are views of a mount in accordance with example embodiments;

FIGS. 7A-7F are views of a swivel mount in accordance with example embodiments;

FIGS. 8A-8B are views of a front housing member in accordance with example embodiments;

FIGS. 9A-9B are views of a back housing member in accordance with example embodiments;

FIG. 10 is a view of a fastening member in accordance with example embodiments;

FIGS. 11A-11B illustrate cross-sections of the front and back housing members in accordance with example embodiments;

FIG. 12 is a view of a mount supporting two devices in accordance with example embodiments;

FIGS. 13A-13C are views of a mount in accordance with example embodiments;

FIGS. 14A and 14B are cross-section views of the mount in accordance with example embodiments; and

FIG. 15 is a view of the mount supporting four devices in accordance with example embodiments.

### DETAILED DESCRIPTION

Example embodiments will now be described more fully with reference to the accompanying drawings. Example embodiments are not intended to limit the invention since the invention may be embodied in different forms. Rather, the example embodiments are provided so that this disclosure will be thorough and complete, and will fully convey the scope of the invention to those skilled in the art. In the drawings, the sizes of components may be exaggerated for clarity.

In this application, when an element is referred to as being “on,” “attached to,” “connected to,” or “coupled to” another element, the element may be directly on, directly attached to, directly connected to, or directly coupled to the other element or may be on, attached to, connected to, or coupled to any intervening elements that may be present. However, when an element is referred to as being “directly on,” “directly attached to,” “directly connected to,” or “directly coupled to” another element or layer, there are no intervening elements present. In this application, the term “and/or” includes any and all combinations of one or more of the associated listed items.

In this application, the terms first, second, etc. are used to describe various elements and components. However, these terms are only used to distinguish one element and/or component from another element and/or component. Thus, a first element or component, as discussed below, could be termed a second element or component.

In this application, terms, such as “beneath,” “below,” “lower,” “above,” “upper,” are used to spatially describe one element or feature's relationship to another element or feature as illustrated in the figures. However, in this application, it is understood that the spatially relative terms are intended to encompass different orientations of the structure. For example, if the structure in the figures is turned over, elements described as “below” or “beneath” other elements would then be oriented “above” the other elements or features. Thus, the term “below” is meant to encompass both an orientation of above and below. The structure may be otherwise oriented (rotated 90 degrees or at other orientations) and the spatially relative descriptors used herein interpreted accordingly.

Example Embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to mounts which may be removably attached to an end of a pole. The mounts may be configured to attach at least one device, for example, a camera, to the pole.

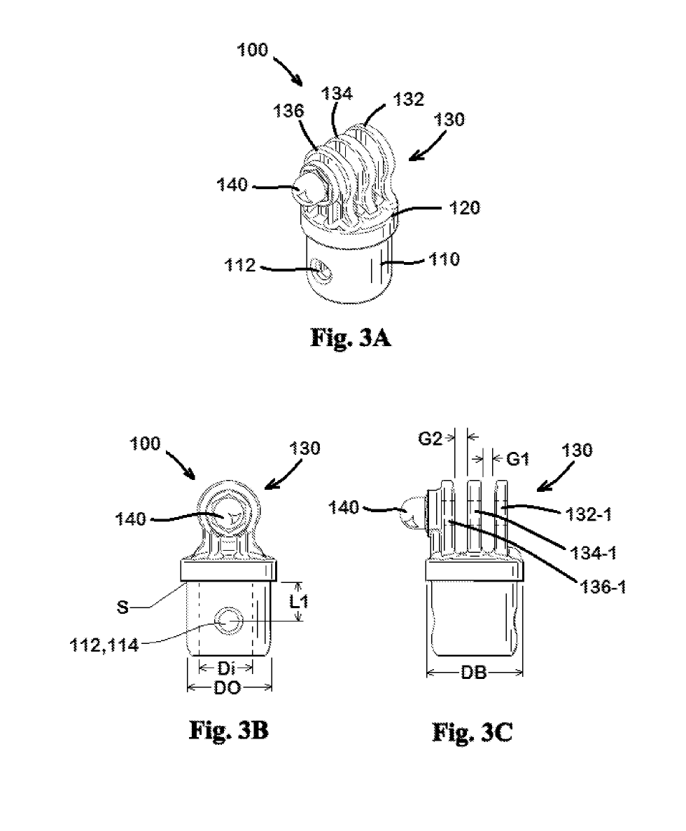

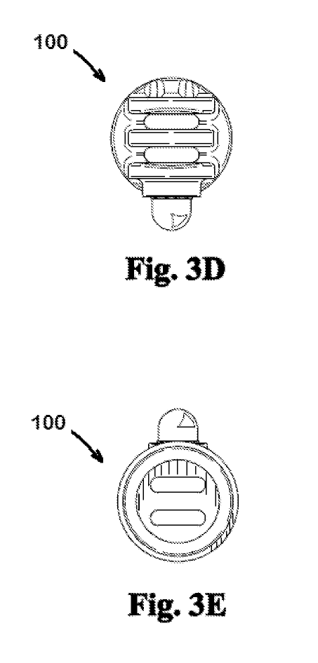

FIG. 3A is a perspective view of a mount 100 in accordance with example embodiments. The mount 100 may be usable for attaching a device, for example, a camera, to a pole. As shown in FIG. 3A, the mount 100 may include a body 110, a base 120, and a plurality of flanges 130 extending from the base 100. In example embodiments the mount 100 may be comprised of a plastic material and may be formed from a casting process or printing process. As such, the mount 100 may be a substantially integral member. The invention, however, is not limited thereto as the mount 100 may be formed from a different material such as, but not limited to, a metal and/or a composite material. In addition, the mount 100 is not required to be formed from a casting process or a printing process. For example, each of the body 110, the base 120, and the plurality of flanges 130 may be separately formed and attached together via a conventional process such as welding or by use of an adhesive.

In example embodiments the base 120 may resemble a short cylinder which may or may not be solid. In example embodiments, the base 120 may have an outer diameter DB of about 1 inch, however, the invention is not limited thereto as the outer diameter DB may be greater than or less about 1 inch.

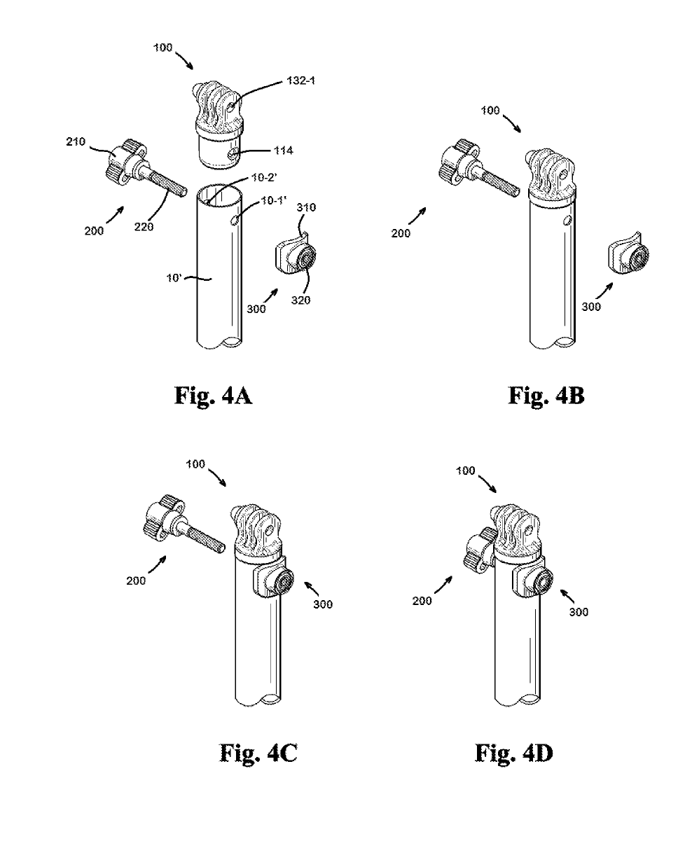

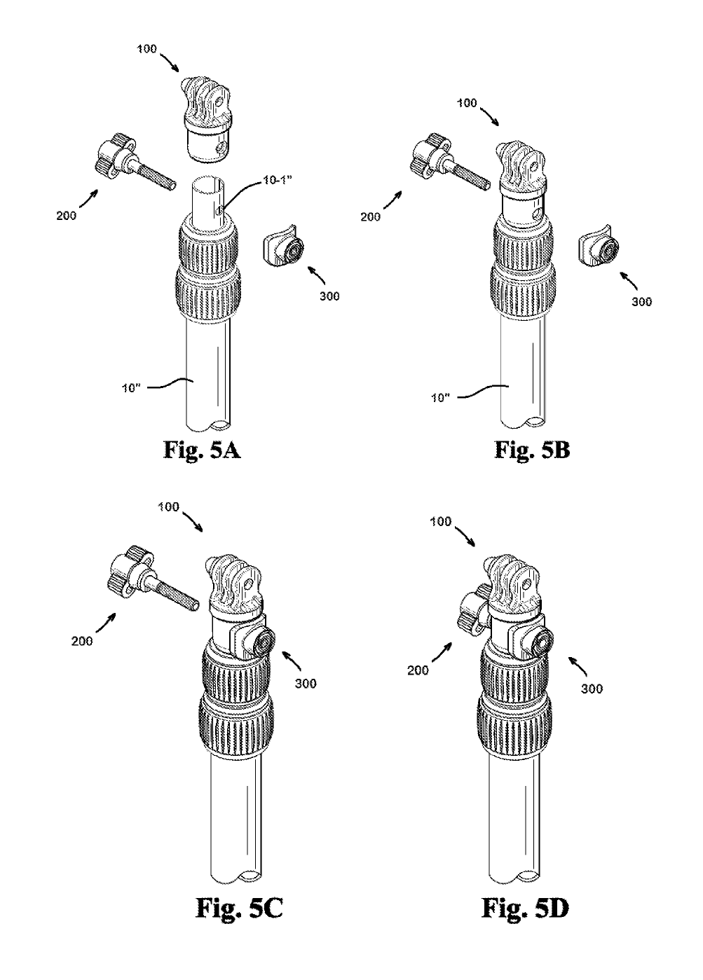

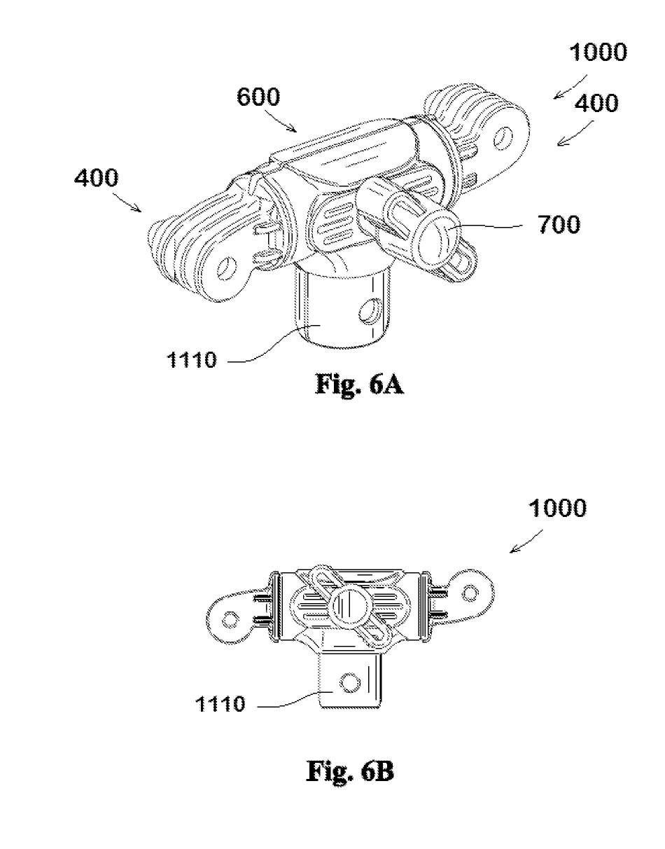

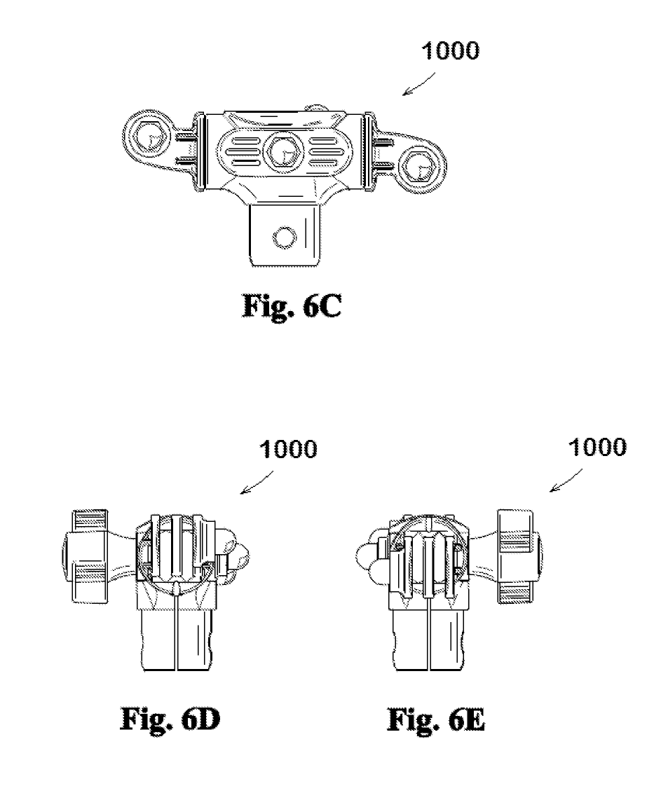

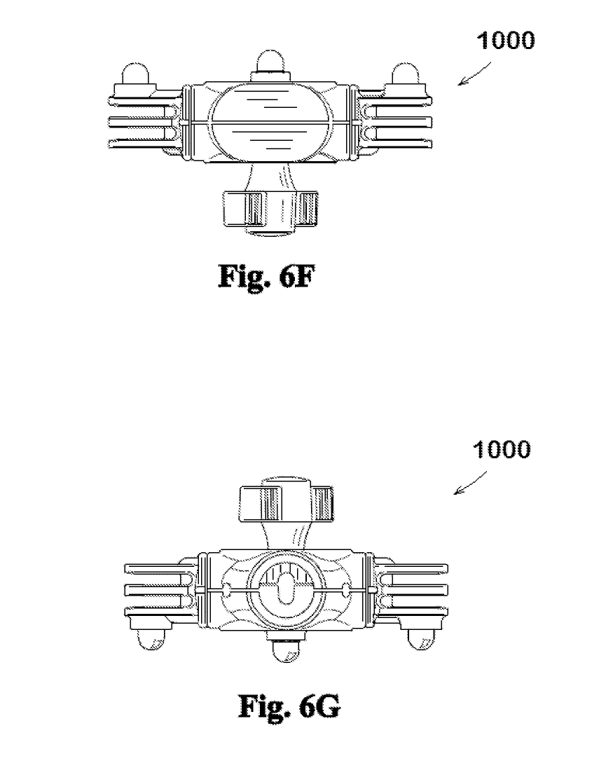

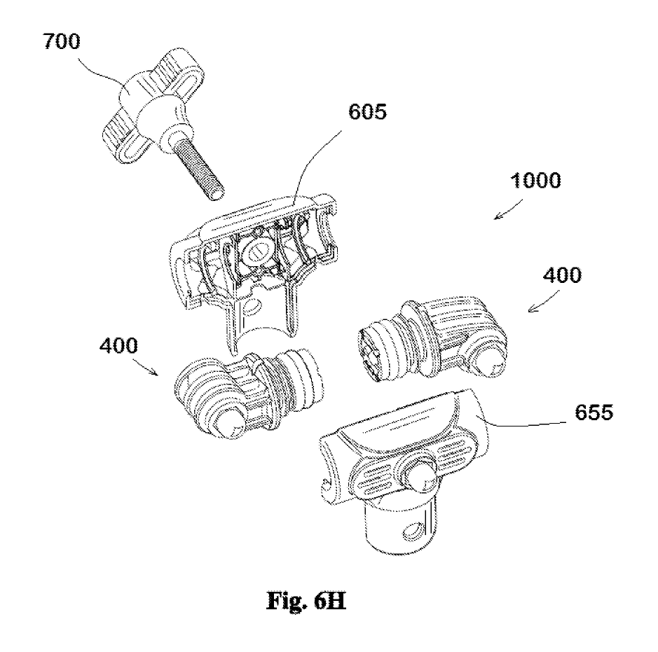

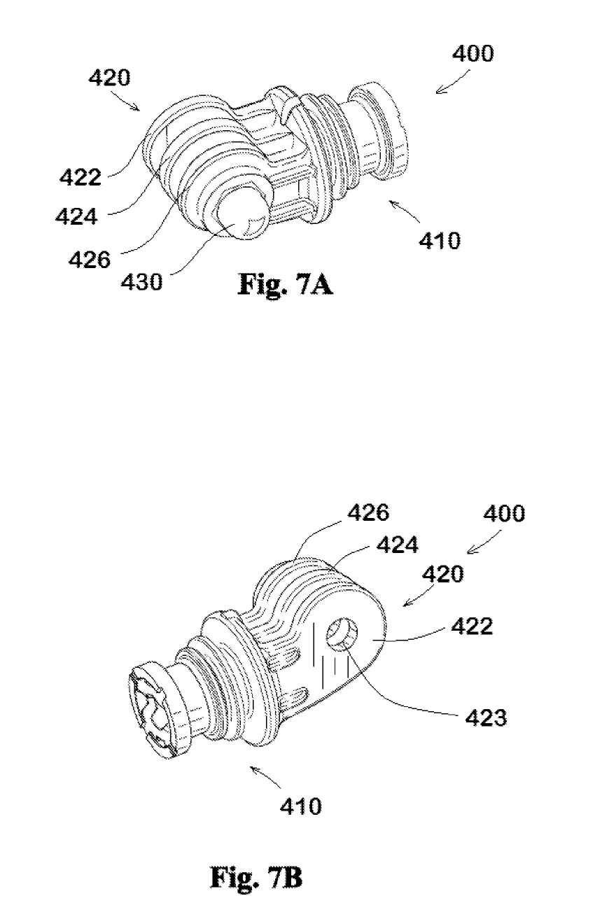

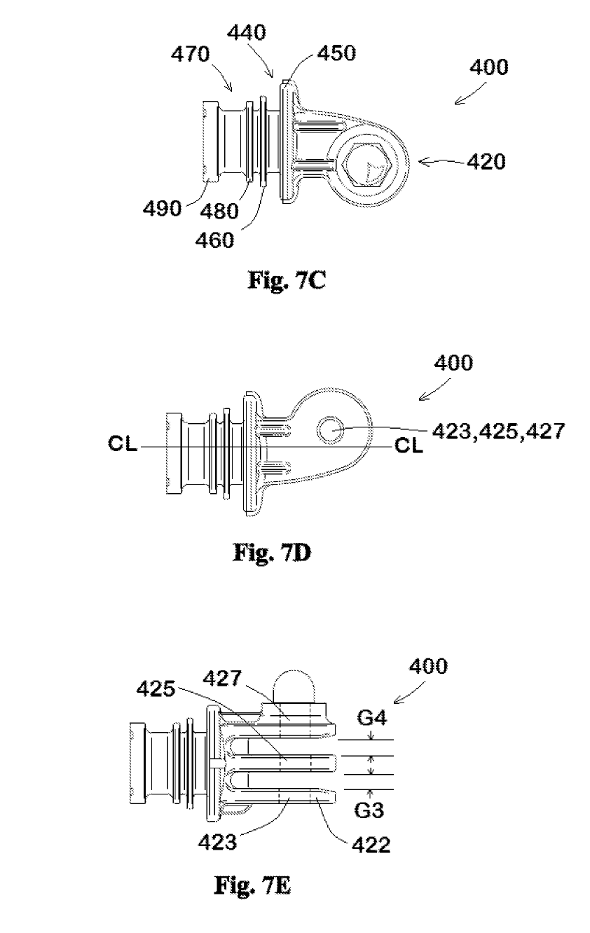

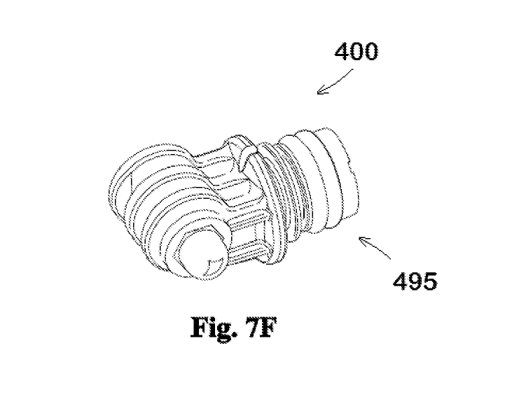

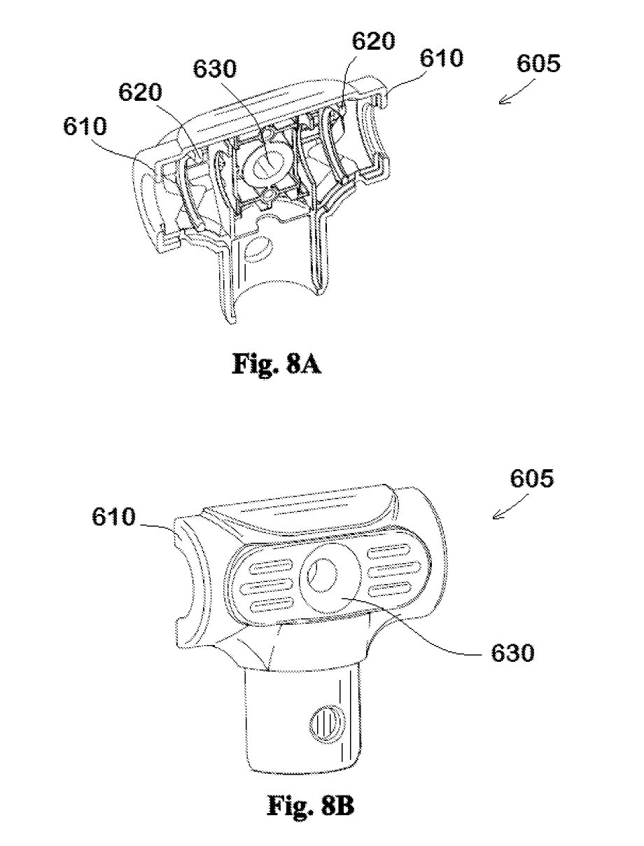

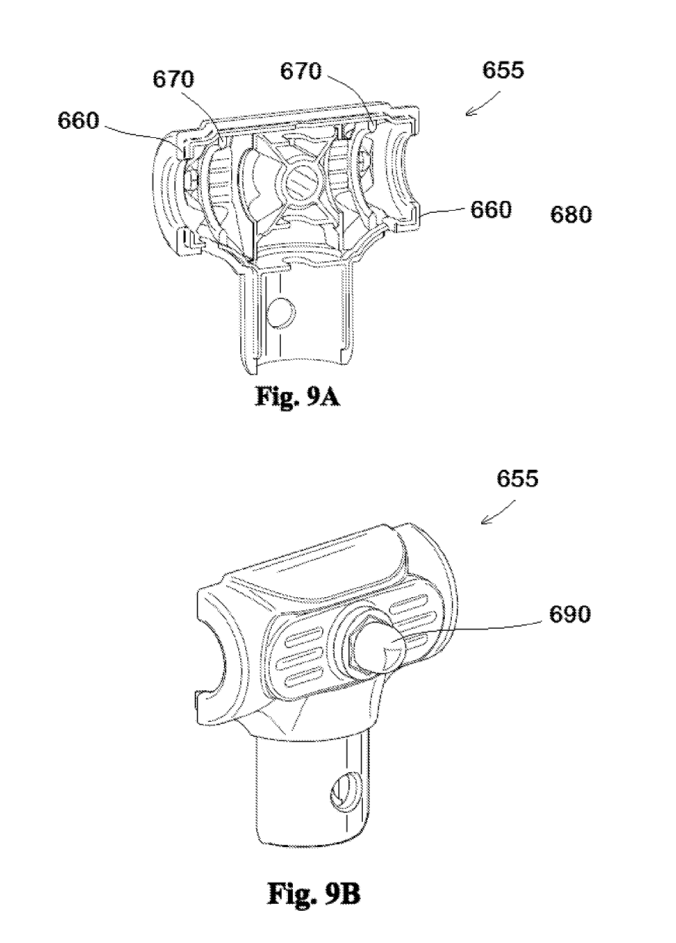

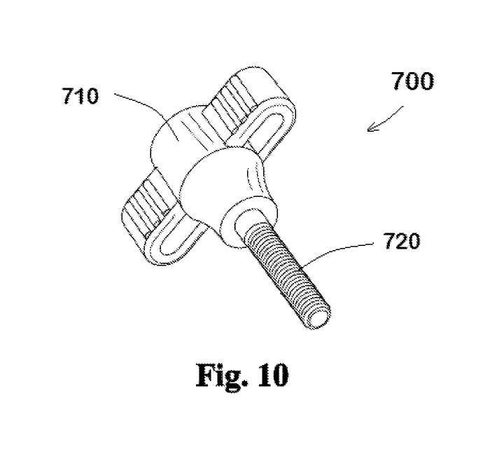

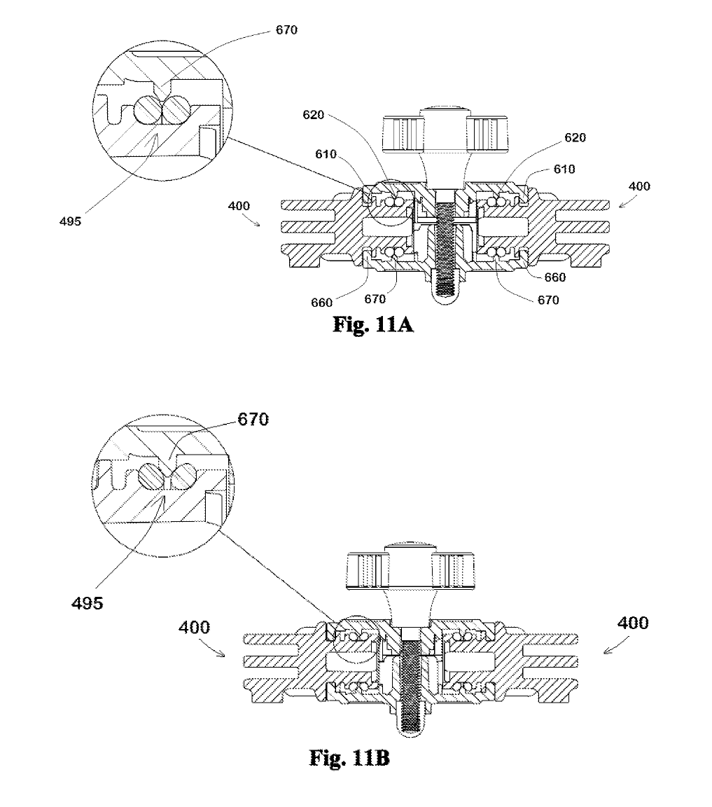

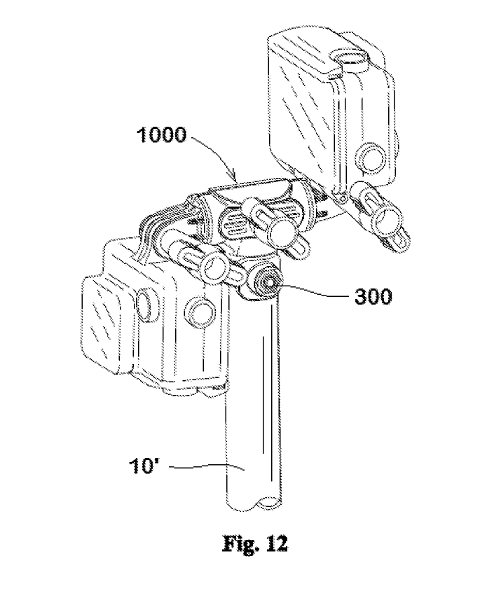

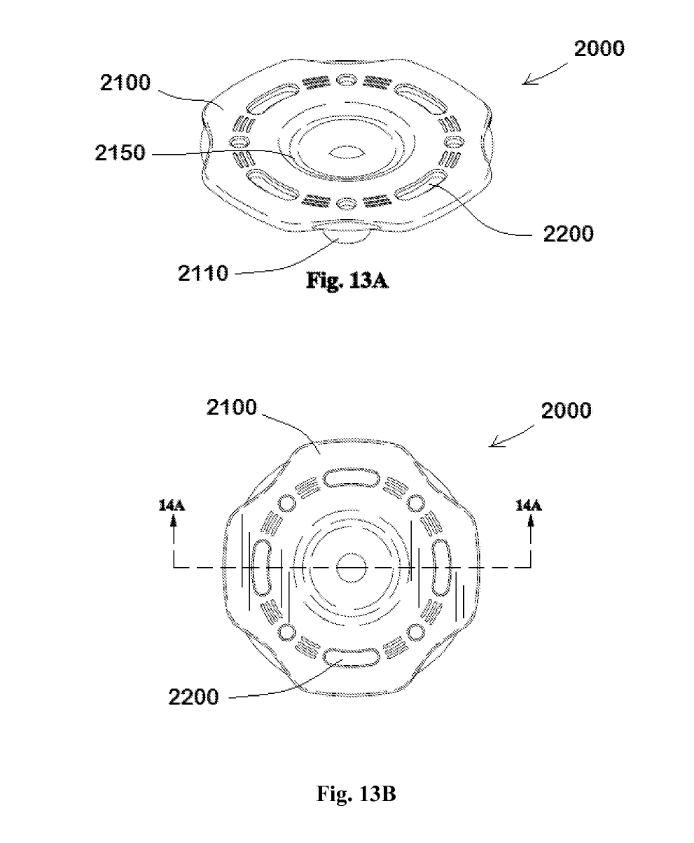

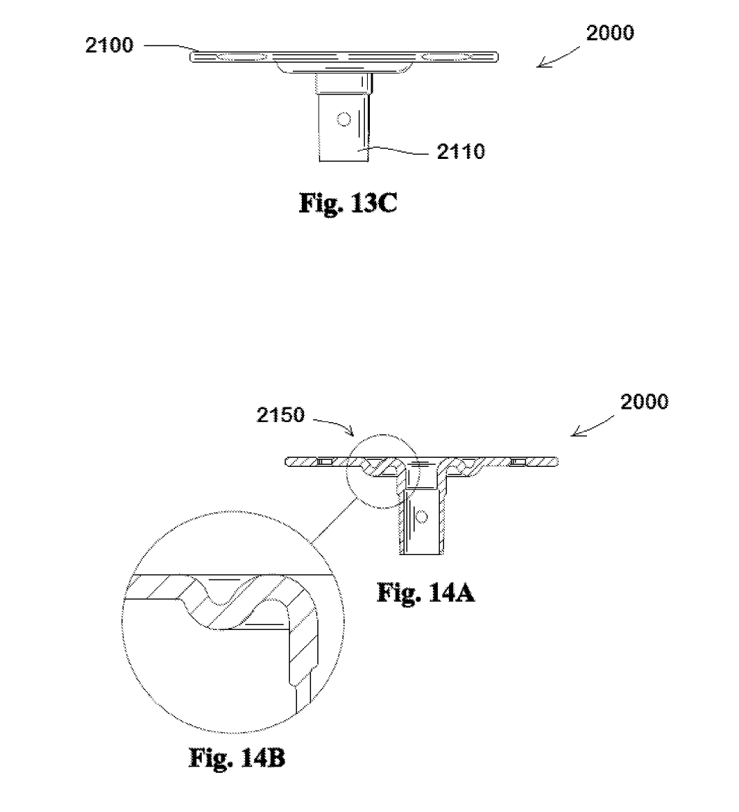

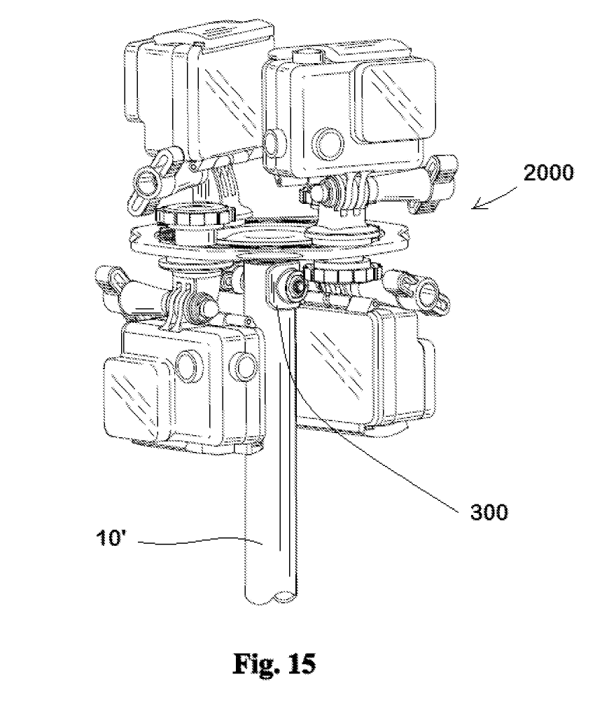

Extending from one side of the base 120 is the body 110. The body 110 may resemble a hollow cylinder having an outer diameter DO and an inner diameter Di. Centerlines of the body 110 and the base 120 may be, but are not required to be, substantially coincident. In example embodiments the outer diameter DO of the body 110 may be smaller than the diameter DB of the base 120. Thus, an interface between the body 110 and the base 120 may form a shoulder S as shown in at least FIG. 3B. In example embodiments the outer diameter DO of the body 110 may be, but is not required to be, smaller than about ⅞ of an inch and the inner diameter Di may be, but is not required to be, larger than about 16 mm. Thus, in example embodiments, the body 110 may be inserted into an end of a tube that has an outer diameter of about ⅞″ (as shown in at least FIGS. 4A-4D). In the alternative, the body 110 may receive an end of a tube that has an outer diameter of about 16 mm (as shown in at least FIGS. 5A-5D). Example embodiments, however, are not limited by the above dimensions. For example, the outer diameter DO of the body 110 may be about 25 mm, 24 mm, 23 mm, 22 mm, 21 mm, 20 mm, 19 mm, 18 mm, 17 mm or 16 mm. As another example, the inner diameter Di may be, but is not required to be, about 24 mm, 23 mm, 22 mm, 21 mm, 20 mm, 19 mm, 18 mm, 17 mm or even 15 mm. In addition, a thickness of the wall forming the body 110 may be about 1 mm, 2 mm, 3 mm, 4 mm, 5 mm, 6 mm, 7 mm, 8 mm, 9 mm or about 10 mm.

In example embodiments the body 110 may further include a pair of apertures 112 and 114. The apertures 112 and 114 may be arranged on the body 110 so that a cylindrical member, for example, a screw, may pass through each of the first and second apertures 112 and 114. In example embodiments one of, or both of, the apertures 112 and 114 may be threaded, however, this aspect of example embodiments is not required since the surfaces forming the apertures 112 and 114 are not required to be threaded.

As pointed out above, the mount 100 may include a plurality of flanges 130. In the nonlimiting example of FIGS. 3A-3E the plurality of flanges 130 includes a first flange 132, a second flange 134, and a third flange 136. Although the plurality of flanges 130 is illustrated as including three flanges 132, 134, and 136, this is not intended to be a limiting feature of the invention as the plurality of flanges 130 may include only a pair of flanges or more than three flanges. In example embodiments, one of the flanges, for example, the third flange 136, may include a threaded member 140 which may or may not be a nut. For example, in one nonlimiting example embodiment, the threaded member 140 is a cap nut (a nut with a domed top over the end thereof) or an acorn nut (a high crown type of cap nut). In the alternative, a different type of threaded member may be used such as, but not limited to, a hex nut, a nylon insert lock nut (also known as a Nylock), a jam, or a nylon insert Jam lock nut. The threaded member 140 may act to receive another threaded member, for example, a screw, that may be used to secure a device, for example, a camera, to the mount 100.

In example embodiments, each of the flanges 132, 134, and 136 of the plurality of flanges 130 may include an aperture. For example, as shown in FIG. 3C, the first flange 132 may include a first aperture 132-1, the second flange 134 may include a second aperture 134-1, and the third flange 136 may include a third aperture 136-1. Furthermore, the apertures 132-1, 134-1, and 136-1 may be substantially in line with one another to that a substantially straight member, for example, a screw, may be inserted through each of the apertures 132-1, 134-1, and 136-1 to enter the threaded member 140.

In example embodiments, the flanges 132, 134, and 136 may be spaced apart to form gaps G1 and G2 therebetween. In example embodiments the gaps G1 and G2 may be sized to receive flanges from a device. For example, the device may be a camera with two flanges which may be inserted into the gaps G1 and G2 of the mount 100. Furthermore, each of the flanges on the camera may include an aperture similar to one of apertures 132-1, 134-1, and 136-1. In example embodiments, because each of the flanges 132, 134, and 136 may include an aperture, for example, a circular hole, and each aperture may be substantially in line with one another, a screw may be inserted through the apertures of the plurality of flanges 130, the apertures of the flanges of the device, and into the threaded member 140. This may allow the device to attach to the mount 100.

FIGS. 4A-4D illustrate the mount 100 being attached to an end of the pole 10′. In example embodiments the outer diameter DO of the body 110 may be smaller than an inner diameter of the pole 10′. As such, the body 110 of the mount 100 may be inserted into an end of the pole 10′ as shown in FIG. 4B. In this particular example, the outer diameter DB of the base 120 may be about the same size as, or slightly larger than, the inner diameter of the pole 10′. Thus, the base 120 may prevent the mount 100 from fully entering the pole 10′. In one nonlimiting example embodiment, a distance L1 (see FIG. 3B) from the shoulder S to the apertures 112 and 114 of the body 110 may be about the same as a distance L2′ from an end of the pole 10′ to a pair of apertures 10-1′ and 10-2′ that may be in an end of the pole 10′ (see FIG. 2A). In this particular nonlimiting example embodiment, when the body 110 of the mount 100 is inserted into and end of the pole 10′, as shown in FIG. 4B, the mount 100 may be manipulated so that the apertures 10-1′ and 10-2′ of the pole 10′ are substantially in line with the apertures 112 and 114 of the mount 100 as an end of the pole 10′ makes contact with the shoulder S.

In example embodiments various fasteners may be used to ensure the mount 100 remains fixed to the pole 10′. For example, in one nonlimiting example embodiment, a mini pole knob 200 having a handle 210 and a threaded body 220 may be used with a nut holder 300 to secure the mount 100 to the pole 10′. The nut holder 300 may include a wrapping plate 310 with threaded member 320. The threaded member 320 may have threads configured to engage the threads of the threaded body 220. The threaded member 320 may, for example, be a lock nut embedded in the wrapping plate 310. In one nonlimiting example embodiment, the wrapping plate 310 may be a plastic member and the threaded member 320 may be press fit into the wrapping plate 310. This aspect of example embodiments, however, is not intended to limit the invention as the nut holder 300, for example, may be an integral member made from a casting or printing process. In this latter embodiment, the threaded member may be machined to have threads configured to engage the threads of the mini pole knob 200. Regardless, the wrapping plate 310 may have a surface which is complementary to the surface of the pole 10′. For example, the wrapping plate 310 may have a surface with a curvature which is substantially the same as the curvature of the outside of the end of the pole 10′, this may allow for the wrapper plate 310 to fit snugly on the pole 10′. In addition, the substantially matching curvatures may also distribute force from the nut holder 300 to the pole 10′ across a larger area of the pole 10′ thereby reducing a stress on the pole 10′.

Referring to FIGS. 4A to 4D, the body 110 of the attachment 100, in one embodiment, may be inserted into the end of the pole 10′ and manipulated so the apertures 10-1′, 10-2′, 112 and 114 are substantially aligned with each other. Thereafter the threaded portion 220 of the minipole knob 200 may be guided through each of the apertures 10-1′, 10-2′, 112, and 114 until it contacts the threads of the nut holder 300. Once contact is made, the minipole 200 may be turned so that the threads of the minipole 200 are engaged with the threads of the nut holder 300 thus securing the attachment 100 to the pole 10′.

FIGS. 5A-5D illustrate the mount 100 being attached to the pole 10″. In example embodiments the inner diameter Di of the body 110 may be about the same size as or larger than an outer diameter DO″ of the pole 10″. As such, an end of the pole 10″ may be inserted into the body 110 of the mount 100 as shown in FIG. 5B. In one nonlimiting example embodiment, the distance from a bottom of the base 120 to the apertures 112 and 114 may be about the same as a distance L2″ from an end of the pole 10″ to a pair of apertures 10-1″ and 10-2″ (see FIG. 2B). In this particular nonlimiting example embodiment, when an end of the tube 10″ is inserted into the body 110 of the mount 100, as shown in FIG. 5B, the mount 100 may be manipulated so that the apertures 10-1″ and 10-2″ of the pole 10″ are substantially in line with the apertures 112 and 114 of the mount 100. As in the previous embodiment, various fasteners may be used to ensure the mount 100 remains fixed to the pole 10″. For example, in one nonlimiting example embodiment a mini pole knob 200 having a handle 210 and a threaded body 220 may be used with a nut holder 300 to secure the mount 100 to the pole 10″.

Thus far example embodiments have described a mount 100 which may be used to attach a device, for example, a camera, to an end of a pole. In example embodiments the mount 100 may have a specially configured body 110 which may be used to attach the mount 100 to different sized of poles. For example, because the body 110 is tubular shaped and an inner diameter of the body 110 is about the same size as, or slightly larger than, an end of the pole 10″, the mount 100 may be used as a female receptacle to receive an end of the pole 10″ which has an outer diameter DO″ smaller than the inner diameter Di of the body 110. On the other hand, the mount 100 is also sized so that it is insertable into an end of pole 10′. In this latter case, the outer diameter DO of the body 110 may be sized to allow it to function as a male type insert and the pole 10′ may act as a female type receptacle. In both cases, however, the attachment 100 is removably attached to the poles 10′ and 10″ which is unlike the prior art mounts which are generally fixed to an end of a pole.

FIGS. 6A-6H are views of another mount 1000 in accordance with example embodiments. In this example, the mount 1000 is configured to attach at least two devices, for example, two cameras, to a pole. As shown in FIGS. 6A-6H, the mount 1000 may be comprised of a housing 600 configured to capture two swivel mounts 400. In example embodiments, the swivel mounts 400 may be configured to interface with a device, for example, a camera.

FIGS. 7A-7F are views of a swivel mount 400 in accordance with example embodiments. As shown in FIGS. 7A-7F, the swivel mount 400 may be comprised of a body 410 with a plurality of flanges 420 extending therefrom. In one particular nonlimiting embodiment, the plurality of flanges 420 may include a first flange 422, a second flange 424, and a third flange 426. Although the plurality of flanges 420 are illustrated as including three flanges 422, 424, and 426, the invention is not limited thereto as the plurality of flanges 420 may include only two flanges or more than three flanges.

In example embodiments the plurality of flanges 420 may be configured to allow for attachment of a device, for example, a camera, to the swivel mount 400. For example, as shown in FIG. 7E, the plurality of flanges 420 may be separated to form gaps G3 and G4. More specifically, the first flange 422 and the second flange 424 may be separated by a distance to form a gap G3 and the second flange 424 and the third flange 426 may be separated by a distance to form a gap G4. The gaps G3 and G4 may function as spaces to receive flanges from a device, for example, a camera. Furthermore, each of the flanges 422, 424, and 426 may include apertures for facilitating a connection of the device to the plurality of flanges 420. For example, the first flange 422 may include an aperture 423 which may be configured to allow a fastener, for example, a screw and or a bolt, to pass therethrough. Similarly, each of flanges 424 and 426 may include an aperture to allow the fastener to pass therethrough. For example, as shown in FIG. 7E, the second flange 424 may include an aperture 425 and the third flange 426 may include an aperture 427 similar to the aperture 423. In at least one embodiment, the apertures 423, 425, and 427 may be substantially aligned so that a member, for example, a screw, may pass through each of the apertures 423, 425, and 427.

In example embodiments, the swivel mount 400 may further include a threaded member 430 which may be arranged in or near the plurality of flanges 420. In example embodiments, the threaded member 430 may or may not be a nut. For example, in one nonlimiting example embodiment, the threaded member 430 is a cap nut or an acorn nut embedded into or attached to the third flange 426. In the alternative, a different type of threaded member may be used such as, but not limited to, a hex nut, a nylon insert lock nut (also known as a Nylock), a jam, or a nylon insert Jam lock nut. The threaded member 140 may act to receive another threaded member, for example, a screw, that may be used to secure a device, for example, a camera, to the swivel mount 400. For example, in one nonlimiting example embodiment, flanges from a camera may be inserted into the gaps G3 and G4 of the plurality of flanges 420. The flanges of the camera may include apertures which may be aligned with the apertures 423, 425, and 427 of the plurality of flanges 420. A threaded member, for example, a screw, may be inserted through the apertures of the plurality of flanges 420 and the apertures of the flanges of the camera until it meets the threaded member 430 which may receive the threads of the screw to secure the camera to the plurality of flanges 420.

In example embodiments, the swivel mount 400 may include a channel 440 configured to receive a flange(s) 610, 660 of the housing 600 (see FIGS. 8A-9B). The channel 440 may be defined by a front wall 450 and an adjacent wall 460. The front wall 450 may, for example, resemble a substantially flat circular plate. The adjacent wall 450 may also resemble a substantially flat circular plate. The invention, however, is not intended to be limited by the aforementioned features as the walls 450 and 460 may have a different configuration. For example, because the front wall 450 is outside of the housing 600 the front wall 450 may have another shape, for example, elliptical or polygonal shape. As for the adjacent wall 450, this wall may resemble a structure other than a circular plate, for example, the adjacent wall 450 may resemble a series of spokes extending outward from the body 410 to help capture the flanges 610, and 620.

In example embodiments, the swivel mount 400 may include a second channel 470. The second channel 470 may be configured to receive a pair of O-rings 495 as shown in at least FIG. 7F. In example embodiments, the pair of O-rings 495 may act as a friction member to lock the swivel mount 400 in a particular configuration in the body 600. The O-rings 495 may be made from a material, for example, rubber, or any other material which has a high coefficient of friction.

In example embodiments, the apertures 423, 425, and 427 may be offset with respect to a centerline CL of the body 410. This may allow for devices attached to the mount 1000 to be attached off center from the housing 6000. For example, as shown in FIG. 6B, the apertures 423, 425, and 427 of the left side swivel mount 400 may be lower that the apertures 423, 425, and 427 of the right side swivel mount 400. This may allow devices, such as cameras and or lights, to be offset from one another when attached to the mount 1000 via the swivel mounts 400.

In example embodiments, the housing 600 may be comprised of a front housing member 605 and a back housing member 655. In example embodiments, the front housing member 605 and the back housing member 655 may be secured to one another via a fastening member 700 (see at least FIG. 6H). The fastening member 700 may, for example, be a lock knob having a handle 710 and a threaded body 720 (see FIG. 10). In one embodiment, the threaded body 720 may be inserted through an aperture 630 of the front housing member 605 and into a threaded member 690 of the second housing member 655. The threaded member 690 may, for example, be a nut. For example, in one nonlimiting example embodiment the threaded member 690 is a cap nut (a nut with a domed top over the end thereof) or an acorn nut (a high crown type of cap nut). In the alternative, a different type of threaded member may be used such as, but not limited to, a hex nut, a nylon insert lock nut (also known as a Nylock), a jam, or a nylon insert Jam lock nut.

In example embodiments, each of the front and back housing members 605 and 655 may include at least one rib. For example, the front housing member 605 may include a pair of ribs 620 and the back housing member 655 may also include a pair of ribs 670. In example embodiments, when the front and back housing members 605 and 655 are secured to one another, the ribs 620 and 670 may form an annular ring. This aspect of example embodiments, however, is not intended to limit the invention. For example, while each of the ribs 620 and 670 are illustrated as being substantially continuous members the invention is not limited thereto. For example, the ribs 620 and 670, rather than being continuous members, may resemble projections extending from an surface of the front and back housing members 605 and 655 towards a middle of the housing 600.

FIGS. 11A and 11B illustrate a cross-section of the mount 1000 in an unlocked and locked position, respectively. FIG. 11A, for example, illustrates the swivel mounts 400 at least partially captured by the housing 600. For example, in FIG. 11A the flanges 610 and 660 are at least partially inserted into the first grooves 410 of the swivel mounts 400. In the unlocked position the ribs 620 and 670 are spaced apart from the O-rings 495 as shown in FIG. 11A. In this configuration, the swivel mounts 400 are free to rotate about their centerline axes while still being captured by the housing 600. Once the swivel mounts 400 are in their desired positions a user may simply turn the fastener 700 to bring the front and back housing member 605 and 655 together. As shown in FIG. 11B, this results in the ribs 620 an 670 pressing against and/or into the pairs the O-rings 495 thus causing friction contact between the O-rings and the ribs 620 and 670. This frictional engagement locks the side swivel mounts 400 in place and inhibits, if not entirely eliminates, the swivel mount's ability to rotate within the housing 600. If a user desired to rotate one or both of the swivel mounts 400, the user could simply unscrew the fastener 700 to separate the front and back housing modules 605 and 655 thereby drawing the ribs 620 and 670 away from the O-rings 495 to disengage the frictional engagement between the O-rings 495 and the ribs 620 and 670.

Although the above description describes swivel mounts 400 as being “locked” into a position by virtue of the friction between the O-rings 495 and the ribs 620 and 670, it is understood a sufficiently high torsional load may be applied to the swivel mounts 400 to overcome the friction forces between the O-rings and the ribs 620 and 670. Thus, the swivel mounts 400 may be rotated by a user provided the user applies a sufficiently high torsional load. In this sense, the O-rings 495 and the ribs 620 and 670 may act as a clutch. Accordingly, it is not necessary that a user separate the front and back housing members 605 and 655 to adjust a position of the swivel mount 400. This aspect of example embodiments also allows for a mount 1000 to resist damage. For example, if a device, for example, a camera or a light, were attached to the swivel mount 400 and the device was inadvertently struck, the interface between the O-rings and the ribs 620 and 670 may allow the swivel mount 400 to rotate to prevent damage to the device attached thereto. Furthermore, because the O-rings 495 may be made from a relatively flexible material, for example, rubber, an inherent torsional flexibility exists between the swivel mount 400 and the housing 600 which encloses it.

In example embodiments, the mount 1000 may be configured so the friction forces between the ribs 620 and 670 and the O-rings 495, which may prevent the swivel mount 400 from rotating, may be overcome before a component of the mount 1000 becomes overstressed. For example, if the swivel mount 400 were comprised of a material having a yield stress of 20 MPa the ribs 620 and 670 and the O-rings 495 may be configured so that if a torsional load were applied to swivel mount 400 the frictional forces between the ribs 620 and 670 and the O-rings 495 would be overcome before the stress in the swivel mount 400 reached 20 MPa. In this way, the swivel mount 400 would rotate before a stress in the swivel mount 400 reaches a failure stress.

Referring back to FIG. 6A and FIG. 12, the mount 1000, when assembled, forms a body 1110 similar to the body 110. Thus, the mount 1000 may be attachable to at least two types of poles in the same manner the mount 100 is attachable to at least two types of poles. That is, the body 1110 may act as both a female receptacle for the pole 10″ and an insert for the pole 10′. FIG. 12 illustrates an example of the mount 1000 attached to an end of the pole 10′. As shown in FIG. 12, the mount 1000 may be attached to the pole 10′ using the previously described fasteners 200 and 300.

Thus far example embodiments have described various embodiments of a a mount that may be used to attach at least one device, for example, a camera, to a pole. The mounts may include a body configured to removably attach to the poles. In addition, the body is sized so as to act as an insert in a pole having a first size and a receiving body for a pole of a different size. However, example embodiments are not limited by the above examples. For example, FIGS. 13A-13C are views of another mount 2000 in accordance with example embodiments. In example embodiments the mount 2000 may be configured to support more than two devices, for example, more than two cameras, and may be configured to mount these devices to a pole in a manner as was previously described.

Referring to FIGS. 13A-13C the mount 2000 may be comprised of a platform 2100 and a body 2110. In example embodiments, the body 2110 may be substantially similar to the body 110 and thus may allow the mount 2000 to be removably attached to at least two different sizes of poles. For example, in example embodiments, the mount 2000 may attach to the poles 10′ and 10″ via the body 2110. As in the mount 100, the mount 2000 may be connected to the poles 10′ and 10″ using fasteners such as by a miniknob 200 and a nut holder 300 (see FIG. 15).

In example embodiments, the platform 2100 may be formed with a ripple 2150 therein. The ripple 2150 may extend in a circular pattern. The ripple 2150 may impart flexibility to the platform 2100 such that if platform 2100 strikes an object (or is struck by an object) the platform 2100 flexes to absorb any shock that may be imparted to the platform 2100. Such a feature is highly desirable in environments where the mount 2000, or the equipment it is attached to, is subject to damage. In one particular nonlimiting example embodiment, the platform 2100 is made from a polypropylene material and/or a glass reinforced nylon which allows the platform to bend up 20% to 30% without imparting a significant inelastic deformation to the platform. For example, in one embodiment where a width of the platform 2100 is about six inches, the platform 2100 may undergo bending deformation such that an outer edge of the platform may displace about 0.6 inches to about 0.9 inches relative to a center of the plate and still return to roughly its original shape. Although the ripple 2150 illustrated in the figures includes three bends, the invention is not limited thereto as the ripple may include more than three bends. In addition, rather than having a ripple 2150, the platform, in the alternative, may be comprised of a relatively flexible member in lieu of the ripple. The flexible member, for example, may be a rubber type ring which may be incorporated into the platform 2100.

In example embodiments the ripple 2150 may allow a portion of the platform 2100 to deflect relative to the body 2110. Thus, the ripple 2150 not only imparts a tipping flexibility but a sideways flexibility as well.

In example embodiments, the platform 2100 may include a plurality of apertures 2200. For example, as shown in FIGS. 13A and 13B, the platform 2100 may include four slotted holes. The holes may allow for a device, for example, a camera, to attach to the platform 2100 using connectors. The slotted nature of the holes allows for some adjustability of placement of the devices when attaching the devices to the platform 2100.

FIG. 15 illustrates the mount 2000 attached to an end of the pole 10′. As shown in FIG. 15, the mount 2000 allows for multiple devices, for example, multiple cameras, to attach to the pole 10′ via the mount 2000.

The mounts 100, 1000, and 2000 and their mounting systems, for example, the fastener 200 and the nut holder 300, have several advantages over the conventional art. For example, in example embodiments the mini pole knob 200 and the nut holder 300 may be easily manipulated by the hand. As such, the mount 100 may be easily attached to poles 10′ and 10″ without the need for additional tools, such as, but not limited to screw drivers, allen wrenches, or plyers. Accordingly, a user may easily change a mount on a pole in the field without having to carry along extra hardware. Such a feature is highly desirable in environments where a user may have to replace a damaged mount. In addition, such a feature also allows a user to quickly and easily change mounts so as to support a different number of devices. For example, a user may initially desire to mount one camera at an end of a pole 10′ or 10″ in which case the user may attach mount 100 to an end of the pole 10′ or 10″. Later the user may desire to mount two cameras at an end of the pole 10′ or 10″. In this case, the user may quickly and easily remove the mount 100 from the end of the pole 10′ or 10″ and replace it with the mount 1000. As yet another example, the bodies 110, 1110, and 2110 may either surround an end of a pole, for example pole 10′ or 10″, or may be inserted into an end of the pole. Regardless, the bodies 110, 1110, 2110 may reinforce and/or protect an end of the pole from damage. This is highly desirable in cases where an end of a pole may be prone to damage, for example, from an impact. In addition, the mounts 100, 1000, and 2000 and their mounting systems allow for a pinned sleeve arrangement to secure a mount to an end of a pole without the need for an adhesive.

Example embodiments also include several features which are advantageous when compared to the prior art. For example, in example embodiments each of the mounts 100, 1000, and 2000 may be made from an impact resistant material. For example, each of the mounts 100, 1000, and 2000 may be largely, if not entirely, make from a polypropylene polymer and/or a glass reinforced composite material. Such materials allow for the mounts 100, 1000, and 2000 to fail in a nondestructive manner so as to avoid damaging the devices or poles that may bet attached thereto. Also, since the mounting systems may be embodied in a minipole knob 200 and a nut holder 300 an end of the pole to which a mount is attached is not required to be threaded. The lack of threads help prevent stress risers that may cause a pole to fail either from a relatively load applied thereto or from fatigue. Furthermore, a lack of threads also means the pole may maintain its full thickness thereby preserving its strength.

Example embodiments of the invention have been described in an illustrative manner It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

1. A mount comprising:
a plurality of flanges configured to attach at least one device to the mount; and
a body having a pair of apertures substantially in line with one another.

2. The mount of claim 1, wherein the body is a substantially cylindrical structure.

3. The mount of claim 2, further comprising:
a base between the plurality of flanges and the body.

4. The mount of claim 3, wherein the base is a substantially cylindrical structure having an outer diameter larger than an outer diameter of the body and an interface between the base and the body forms a shoulder.

5. The mount of claim 1, further comprising:
a threaded member, wherein the plurality of flanges include a plurality of apertures aligned with threaded member.

6. The mount of claim 1, further comprising:
a housing; and
a swivel mount captured by the housing, wherein the plurality of flanges are arranged at an end of the swivel mount.

7. The mount of claim 6, further comprising:
a pair of O-rings arranged in a first groove of the swivel mount, wherein the housing includes at least one rib configured to interface with the pair of O-rings.

8. The mount of claim 7, wherein the housing includes
a front housing member, and
a back housing member, wherein the front housing member and the back housing member include a flange configured to insert into a second groove of the swivel mount and the at least one rib is a first rib on the front housing member and a second rib arranged on the back housing member.

9. The mount of claim 7, further comprising:
a fastening member including first threads; and
a threaded member containing second threads configured to engage the first threads, wherein when the fastening member is rotated with respect to threaded member the front housing member is moved towards the back housing member causing the first rib and the second rib to press into the pair of O-rings.

10. The mount of claim 8, wherein when a torsional load applied to the swivel mount the swivel mount rotates before a stress in the mount exceeds a failure stress.

11. A system comprising:
a pole;
the mount of claim 1; and
at least one fastener configured to removably attach the mount to the pole, wherein the body is configured to one of insert into an end of the pole and enclose an end of the pole.

12. The system of claim 11, wherein the at least one fastener is comprised of a threaded cylindrical member and a nut holder.

13. The system of claim 12, wherein the threaded cylindrical member is a minipole knob.

14. The system of claim 12, wherein the nut holder includes a wrapper configured to wrap around the pole.

15. The system of claim 14, wherein the wrapper includes a surface having a curvature substantially the same as one of the body and the pole.

16. The system of claim 14, wherein the nut holder includes a nut embedded therein.

17. The system of claim 1, wherein the body has an outer diameter of about ⅞″ and an inner diameter of about 16 mm.

18. A mount comprising:
a platform having a ripple configured to impart flexibility to the platform; and
a body having a pair of apertures substantially in line with one another.

19. The mount of claim 18, wherein the platform includes a plurality of slotted apertures to facilitate connection of a device to the platform.

20. A system comprising:
a pole;
the mount of claim 17; and
at least one fastener configured to removably attach the mount to the pole, wherein the body is configured to one of insert into an end of the pole and enclose and end of the pole.
